(19) United States
(12) Patent Application Publication
(10) Pub. No.: US 2011/0219950 A1
(43) Pub. Date: Sep. 15, 2011

(54) SINGLE-BED RADIAL ADSORBERS IN SERIES

(75) Inventors: Guillaume Rodrigues, Guyancourt (FR); Benoit Davidian, Saint Maur des Fosses (FR)

(73) Assignee: L'AIR LIQUIDE SOCIETE ANONYME POUR I'ETUDE ET I'EXPLOITATION DES PROCEDES GEORGES CLAUDE

(21) Appl. No.: 13/129,976

(22) PCT Filed: Nov. 6, 2009
(86) PCT No.: PCT/FR09/52144

§ 371 Date: May 18, 2011

(30) Foreign Application Priority Data
Nov. 18, 2008 (FR) 0857819

(51) Int. Cl. B01D 53/02

(52) U.S. Cl. 95/96; 95/117; 96/131

(57) ABSTRACT

The invention relates to a method for purifying a feedstock gas flow including a main compound, water (H2O) and carbon dioxide (CO2) as well as so-called secondary impurities, that comprises: a) feeding the feedstock gas flow into at least one 2-grid radial adsorber comprising as a single adsorption bed an activated alumina or silica gel bed on which H2O is preferably adsorbed; b) feeding the gas resulting from step a) into at least one 2-grid radial adsorber comprising as a single adsorption a molecular sieve bed on which CO2 and secondary impurities are preferably adsorbed; and c) recovering a gas resulting from step b) enriched with the main compound and suitable for cryogenic distillation.

The present invention relates to an adsorption process for purifying a feed gas stream, particularly a stream of air containing water and carbon dioxide, employing groups of adsorbers placed in series.

This process in general precedes a cryogenic distillation separation process.

It is known that atmospheric air contains compounds that have to be eliminated before said air is introduced into the heat exchangers of the cold box of an air separation unit, especially the main compounds carbon dioxide (CO₂) and water vapor (H₂O) as well as with what are called secondary impurities such as nitrogen oxides and/or hydrocarbons for example.

Indeed, in the absence of such pretreatment of the air to eliminate its impurities therefrom, especially CO₂ and water, these impurities will solidify as ice when the air is cooled to a cryogenic temperature typically equal to or below about −150° C., which may result in problems of the equipment, especially the heat exchangers and distillation columns, being blocked. Likewise, the secondary impurities (NₓO_{y} and CₙHₘ), if they are not stopped predominantly in the purification at the top of the cold box, accumulate within the reboiler of the low-pressure distillation column and may damage this heat exchanger. The term NₓO_{y} is understood to mean nitrogen oxides and the term CₙHₘ is understood to mean hydrocarbons.

Currently, this pretreatment of the air is carried out, depending on the case, by TSA (temperature swing adsorption) or PSA (pressure swing adsorption) processes. The term PSA refers here to actual PSA processes, to VSA (vacuum swing adsorption) processes and to VPSA processes and the like.

The invention applies to the various processes and units employing radial adsorbers, in particular processes and units operating in TSA mode, that is to say with a temperature swing.

Conventionally, a TSA process cycle for air purification comprises the following steps:
a) purification of the air by adsorbing the impurities at super atmospheric pressure and at ambient temperature;
b) depressurization of the adsorber down to atmospheric pressure;
c) regeneration of the adsorbent at atmospheric pressure, especially by the waste gases, typically impure nitrogen coming from an air separation unit and heated to a temperature usually between 100 and 250° C. by means of one or more heat exchangers;
d) cooling of the adsorbent down to ambient temperature, especially by continuing to introduce air into said waste gas coming from the air separation unit, but not heated; and
e) repressurization of the adsorber with purified air coming for example from another adsorber which is in production phase.

Generally, the air pretreatment devices comprise two adsorbers operating alternately, that is to say one of the adsorbers is in production phase while the other is in regeneration phase. The production phase corresponds to the purification of the gas mixture by adsorption of the impurities.

The regeneration phase corresponds to desorption of the impurities, which are retained on the adsorbent during the adsorption step, by heating the adsorbent with the waste gases heated to a temperature between for example 100° C. and 250° C. This phase comprises in particular the depressurization, heating, cooling and repressurization steps.

A step of paralleling the two adsorbers, of relatively long duration, i.e. ranging from a few seconds to a few minutes, is generally added at the start or the end of the regeneration phase. Such TSA air purification processes are described in particular in the documents U.S. Pat. No. 3,738,084 and FR-A-7 725 845.

Whenever the throughputs to be purified become substantial, it is known to use radial adsorbers as taught in the documents U.S. Pat. No. 4,541,851 or EP-A-1 638 669. Radial adsorbers make it possible to purify by adsorption, in a reliable and repetitive manner, large quantities of fluid, especially atmospheric air, whilst still maintaining a good distribution of the treated fluid and fluid flow velocities compatible with the mechanical properties of the adsorbent particles used.

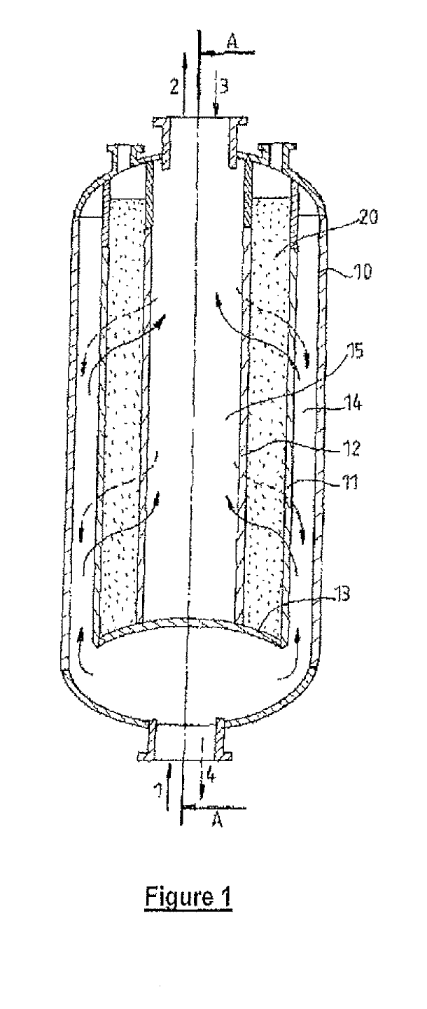

The operation of a radial adsorber is shown in FIG. 1. The fluid 1 to be purified or separated enters at the bottom of the radial adsorber 10, flows through the adsorbent mass 20 and the product leaves at the top 2. During regeneration, the regeneration fluid 3 enters countercurrently via the top and desorbs the impurities contained in the adsorbent mass 20, while the waste gas 40 leaves at the bottom.

The adsorber 10 itself consists of a cylindrical shell of vertical axis AA and two end walls. The adsorbent mass is kept in place by means of a perforated external grid 11 and a likewise perforated internal grid 12 that are fastened to the upper end wall and by means of an unperforated plate 13 at the bottom. The gas 1 flows vertically on the periphery in the external free zone 14 between the cylindrical shell and the external grid, passes radially through the adsorbent mass 20 and then flows vertically in the internal free zone 15 before leaving the adsorber via the top. Regeneration is performed in the opposite sense.

To eliminate the CO₂ and water from the air, it is general to use adsorbers in parallel, each comprising two beds:
a first bed of activated alumina or silica gel, on which the water is preferentially adsorbed; and
a second bed of molecular sieve, on which the CO₂ is preferentially adsorbed.

Each adsorber therefore comprises three grids. However, for mechanical construction reasons, the use of these three grids limits the height of the adsorber. Specifically, the diameter of these radial adsorbers may range up to 6 or 7 meters, although it is sometimes impossible to reach such sizes, often for transport reasons. For a fixed adsorber diameter, it is not always possible to increase the height of the adsorber, in order to increase the capacity thereof, because of the assembly of these three grids. This assembly may be carried out horizontally, the grids being inserted in succession, concentrically, starting from the internal grid. The end of each grid is fastened in succession to an end wall, the other end being freed so as to enable the next grid to be inserted thereinto. Any deviation from the horizontal of the first assembled grid, i.e. the internal grid which is also the most flexible one, must not exceed a certain length so as to be able to enable the intermediate grid to pass therethrough.

Apart from the mechanical construction problems, the use of radial adsorbers of too large a size may result in poor gas distribution in the beds because of the large flow rate gradient along these beds (in the external distribution space).

Moreover, if a gas containing a large quantity of water, i.e. a gas saturated at low pressure and at high temperature, is considered, the amount of alumina necessary will be very large and the amount of sieve will be small relative to this amount of alumina. This sieve/alumina disproportion will accentuate the difficulties in constructing said radial adsorber, since the diameter of the inner and intermediate grids will be similar, thereby further limiting the maximum height of the adsorber. Furthermore, in this situation in which the internal and intermediate grids are close together, it will be difficult to ensure a uniform thickness of the sieve bed because of non-ideal characteristics and various deformations of the grids, which could lead to preferential pathways in the zones where the sieve thickness is less.

Given the abovementioned limitations, several solutions have been envisioned while being able to treat throughputs that a single pair of 3-grid adsorbers cannot handle. These solutions are described in the document WO 2008/078028 and consist of the addition of radial adsorbers in parallel, the use of three bottles each treating half the throughput, or the installation of two pairs of adsorbers in parallel.

Taking as an example a throughput to be treated representing 800,000 Nm³/h of air at 6 bar, it is not possible to treat such a throughput using two 3-grid adsorbers. It is possible to choose, for example, to install two units each comprising two 3-grid adsorbers, each treating one half of the throughput in question.

It is also necessary to provide a flow control system in order to ensure that the flow of air clearly separates into two between the two units (flowmeters on the air intake with a control valve, and the same thing in the regeneration gas, thereby causing an additional pressure drop.

It should also be noted that each of the two units must be provided with its own operating valves and its own regeneration heater.

Starting from this situation, one problem that arises is how to provide a simplified and improved process for purifying a gas stream with the aim of eliminating the water and carbon dioxide therefrom.

One solution of the invention is a process for purifying a feed gas stream comprising a main component, water (H₂O) and carbon dioxide (CO₂), together with what are called secondary impurities, in which:
a) the feed gas stream is introduced into at least one 2-grid radial adsorber containing, as single adsorption bed, a bed of activated alumina or silica gel on which H₂O is preferentially adsorbed.
b) the gas resulting from step a) is introduced into at least one 2-grid radial adsorber containing, as single adsorption bed, a molecular sieve bed on which CO₂ and the secondary impurities are preferentially adsorbed; and
c) a gas resulting from step b) enriched in the main component is recovered and capable of undergoing a cryogenic distillation.

The term “secondary impurities” is understood to mean nitrogen oxides and hydrocarbons.

The invention presented here is based partly on the omission of the intermediate grid, implying the use of a single adsorbent per bottle. In the absence of this intermediate grid, the adsorber is then referred to as a “2-grid” or single-bed adsorber, therefore allowing a much simpler and less expensive construction, making it possible to increase the size of the adsorber and therefore the air throughput that it can treat, and solving any problems regarding the thickness uniformity of the sieve bed.

Depending on the case, the process according to the invention may have one or more of the following features:
the molecular sieve in step b) is a type X zeolite;
the adsorber employed in step b) has a size smaller than or equal to the size of the adsorber employed in step a) in a ratio ranging from 0.4 to 1;
each adsorber is subjected to a pressure/temperature cycle, the duration of the cycle of the adsorber(s) employed in step a) being between 90 and 600 minutes and the duration of the cycle of the adsorber(s) employed in step b) being less than or equal to the duration of the cycle employed in step a) in a ratio of between 0.4 and 1, preferably between 0.5 and 0.8;
the hourly molar flow rate of the treated feed gas stream is between 100,000 Nm³/h and 1,000,000 Nm³/h;
in step b) the secondary impurities are stopped with a stopping factor of between 30% and 100%, preferably between 60% and 100%;
in step a) two 2-grid radial adsorbers containing, as single adsorption bed, a bed of activated alumina or silica gel and operating alternately (i.e. one of the adsorbers is in the regeneration phase while the other is in the production phase, and vice versa) are employed and/or in that, in step b) two 2-grid radial adsorbers containing, as single adsorption bed, a molecular sieve bed and operating alternately are employed;
in step a) N pairs of 2-grid radial adsorbers containing, as single adsorption bed, a bed of activated alumina or silica gel are employed, the adsorbers of a given pair operating alternately and the end pairs following the same pressure cycle in parallel and/or in that in step b) N′ pairs of 2-grid radial adsorbers containing, as single adsorption bed, a molecular sieve bed are employed, the adsorbers of a given pair operating alternately and the N′ pairs following the same pressure cycle in parallel, with N≧1 and N′≧1;
the hourly molar flow rate of the treated feed gas stream is between 100,000 Nm³/h and 3,000,000 Nm³/h;
the adsorbers employed in step a) are periodically regenerated with a regeneration gas heated by means of a first heater and in that the adsorbers employed in step b) are periodically regenerated with a regeneration gas heated by means of a second heater;
the adsorbers employed in steps a) and b) are periodically regenerated with a regeneration gas heated by means of a single heater; and
the feed gas is air and the main component is oxygen.

Preferably, each adsorber has a diameter of greater than 4.5 m and possibly up to 7 meters.

Moreover, the pressure of the feed gas stream is preferably between 1 bar and 35 bar absolute.

The secondary-impurity stopping factor is defined as the percentage of secondary impurities entering the purification stage that have been retained in the adsorber during the cycle. Depending on the adsorbent and the type of impurity in question, during a cycle the content of secondary impurities stopped in the purification stage varies from 30% to 100%.

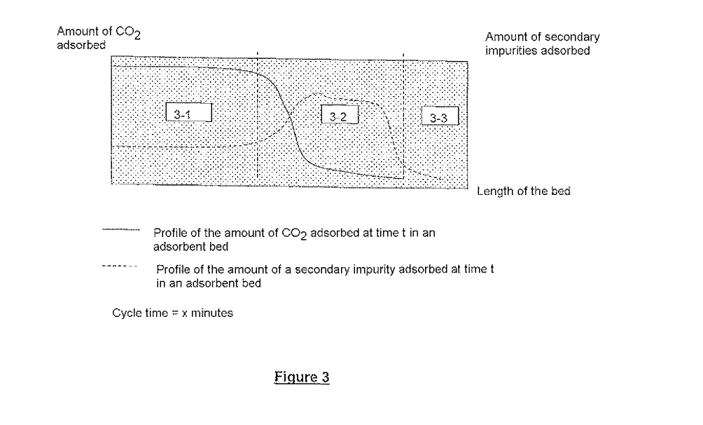

When an impurity with a top-hat profile enters an adsorption bed, the mean transit time of the impurity is directly linked to the adsorption capacity of the bed, whereas the deformation of the top-hat front is linked to the kinetics, to the thermal effects or to the dispersion effects that may exist in the adsorption column in question. Three zones may therefore be distinguished in the bed in question (FIG. 3): an impurity-saturated zone 3-1) in which the amount adsorbed per gram of adsorbent is a maximum; a zone 3-2) in which the amount adsorbed is less than the maximum adsorbable amount under the temperature and pressure conditions in question; and a third zone 3-3) in which no impurity is adsorbed. The zone 3-1) is called the saturated zone while the second zone 3-2) is called the MTZ (mass transfer zone).

During common adsorption of CO₂ and secondary impurities, a competitive adsorption effect, called coadsorption, takes place in which the CO₂, because of the strength of the electrostatic interactions with the adsorbent and the CO₂ partial pressure, which is well above that of the secondary impurities (for example, the N₂O partial pressure is about 100 times lower than the CO₂ partial pressure, whereas their respective affinities with the adsorbent are similar), impedes the adsorption of the secondary impurities. Within the CO₂-saturated zone 3-1), the amount of secondary impurities adsorbed is then minimal, whereas in the mass transfer zone 3-2), the amount of secondary impurities adsorbed is greater the lower the amount of CO₂ adsorbed. It is even possible to observe a local increase in the amount of secondary impurity adsorbed in or slightly downstream of the CO₂ MTZ, due to the increase in the partial pressure of the secondary impurities propelled by the advancing CO₂ front.

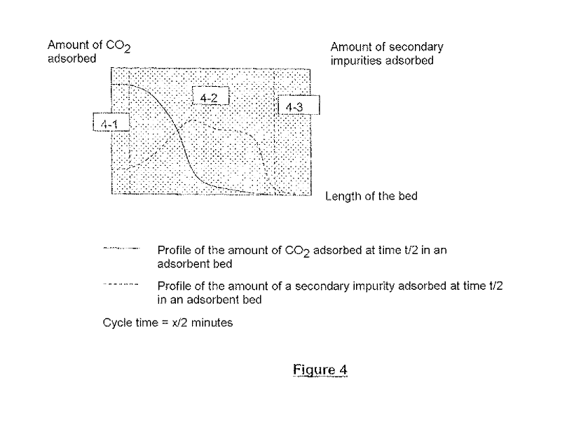

It will therefore be understood that the shorter the cycle, the smaller the CO₂-saturated zone relative to the mass transfer zone, this having the effect of increasing the secondary-impurity stopping factor. This phenomenon is illustrated by FIG. 4, which shows what would happen to the relative size of the saturated zone and that of the mass transfer zone if the cycle time were to be halved.

The subject of the present invention is also a plant for purifying a feed gas stream comprising oxygen (O₂), water (H₂O) and carbon dioxide (CO₂), said plant comprising at least one radial adsorber containing, as single adsorption bed, a bed of activated alumina or silica gel and at least one radial adsorber containing, as single adsorption bed, a molecular sieve bed, characterized in that the two radial adsorbers are placed in series.

Preferably, said plant comprises at least one pair of radial adsorbers containing, as single adsorption bed, a bed of activated alumina or silica gel and operating alternately and at least a second pair of radial adsorbers containing, as single adsorption bed, a molecular sieve bed and operating alternately, the first and second pairs of radial adsorbers being placed in series.

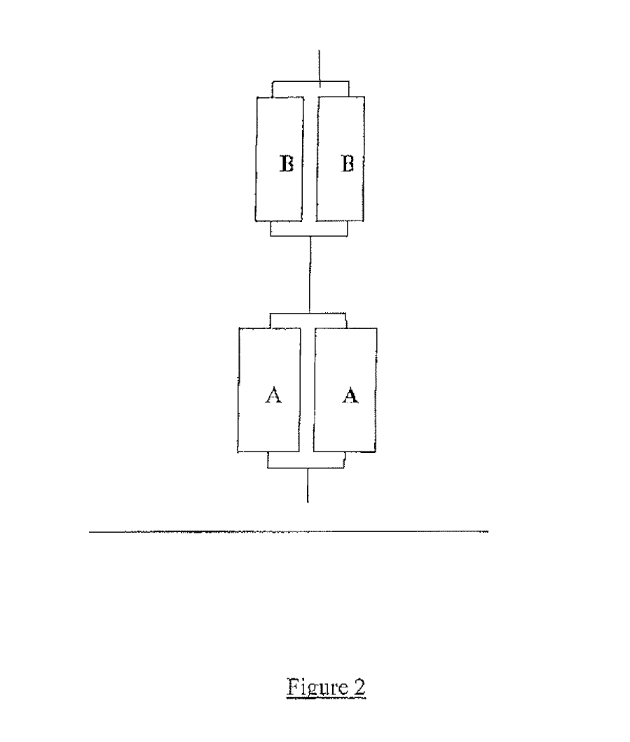

FIG. 2 illustrates a “series” plant according to the invention. The adsorbers “A” are adsorbers containing only a bed of activated alumina or silica gel and the adsorbers “B” are adsorbers containing only a molecular sieve bed.

In the process and the plant according to the invention, adsorbers containing a single adsorbent bed are employed. Also, each of these radial adsorbers comprises only two grids and not three grids like the radial adsorbers of the prior art employed for a similar purification. The height of these 2-grid adsorbers is therefore increased.

By way of example, at 6 bar, 30° C. and for a diameter close to 6 meters, the maximum throughput treated using a unit comprising two 2-grid adsorbers is about 700,000 Nm³/h to treat a larger throughput, one would choose to use two units in parallel, each comprising two 2-grid adsorbers, in other words using four adsorbers.

In the process according to the invention, it is possible to treat 850,000 Nm³/h using two units in series, each comprising two 2-grid adsorbers, in other words using four adsorbers.

Thus, the process according to the invention makes it possible to treat the throughput in question using the same number of adsorbers, while reducing the manufacturing cost of the adsorbers and improving the secondary-impurity stopping factor.

The cycle time of a standard 3-grid unit is set by the regeneration time of the adsorber, which is determined, for an available regeneration rate, by the thermal inertia of the adsorber and especially by the amount of water adsorbed on the alumina. In the process according to the invention, the cycle time of the adsorber containing a bed of activated alumina or silica gel will therefore be close to that of the standard unit containing an alumina bed and a molecular sieve bed. The cycle time of the adsorber containing a molecular sieve bed itself may be reduced since it will essentially correspond to the thermal inertia. This is because here there is no longer water to be desorbed, but only CO₂ and secondary impurities, requiring a very small amount of energy (in comparison with the desorption energy required by regenerating the large amount of water on the alumina). This shorter cycle time enables the size of the adsorber and therefore its cost to be reduced.

In the context of standardizing adsorber sizes (and ranges or apparatus), the CO₂-stopping adsorber may be a water-stopping adsorber of smaller size.

This cycle reduction may also be advantageous for stopping the secondary impurities since the CO₂ mass transfer zone will be longer, relative to the saturation zone, the shorter the cycle time. Since the co-adsorption of CO₂ and secondary impurities is less competitive in the MTZ, the secondary-impurity stopping factor will be improved thereby. Of course, this relative size of the MTZ compared with the saturated zone also introduces an unfavorable nonlinearity in the CO₂ size of the bed as a function of the cycle time, in other words halving the cycle time will not result in the necessary volume of adsorbent being halved, because of the adsorption kinetics.

In the process according to the invention, there is no longer a need for a flow control system since the entire air flow passes through the adsorbers in series.

It should be noted that each adsorber or pair of adsorbers is provided with its own operating valves and its own regeneration heater. The size of the heater will be different depending on whether it is the alumina or the sieve that is regenerated.

Starting from the principle that the adsorbers containing a single bed will be sized in such a way that the pressure drop of the two adsorbers in series is close to that obtained on standard adsorbers (containing two beds) in parallel (the thickness of the bed of the all-sieve adsorber will be relatively small), with independent regeneration of the two pairs of adsorbers, a reduction in the pressure drop will be expected in regeneration.

Thus, it is possible to imagine cycle and heating times such that a single heater is useful for regenerating the alumina or silica gel and the sieve, either sequentially or at the same time (the duration in respect of the sieve nevertheless remaining shorter than that in respect to the alumina).

In conclusion, in addition to the advantage in terms of manufacturing costs and simplicity mentioned above, the process according to the invention has the advantage of providing a different cycle time according to the adsorber in question: the cycle time of an adsorber containing only a molecular sieve will be shorter, this being advantageous in terms of the secondary-impurity stopping factor.

1-12. (canceled)

13. A process for purifying a feed gas stream comprising a main component, water (H₂O) and carbon dioxide (CO₂), together with secondary impurities, in which:
a) the feed gas stream is introduced into at least one 2-grid radial adsorber containing, as single adsorption bed, a bed of activated alumina or silica gel on which H₂O is preferentially adsorbed;
b) the gas resulting from step a) is introduced into at least one 2-grid radial adsorber containing, as single adsorption bed, a molecular sieve bed on which CO₂ and the secondary impurities are preferentially adsorbed; and
c) a gas resulting from step b) enriched in the main component is recovered and capable of undergoing a cryogenic distillation.

14. The process of claim 13, wherein the molecular sieve in step b) is a type X zeolite.

15. The process of claim 13, wherein the adsorber employed in step b) has a size smaller than or equal to the size of the adsorber employed in step a) in a ratio ranging from 0.4 to 1.

16. The process of claim 13, wherein each adsorber is subjected to a pressure/temperature cycle, the duration of the cycle of the adsorber(s) employed in step a) being between 90 and 600 minutes and the duration of the cycle of the adsorber(s) employed in step b) being less than or equal to the duration of the cycle employed in step a) in a ratio of between 0.4 and 1.

17. The process of 13, wherein, in step a) two 2-grid radial adsorbers containing, as single adsorption bed, a bed of activated alumina or silica gel and operating alternately are employed and/or in that, in step b) two 2-grid radial adsorbers containing, as single adsorption bed, a molecular sieve bed and operating alternately are employed.

18. The process of claim 13, wherein, in step a) N pairs of 2-grid radial adsorbers containing, as single adsorption bed, a bed of activated alumina or silica gel are employed, the adsorbers of a given pair operating alternately and the end pairs following the same pressure cycle in parallel and/or in that in step b) N′ pairs of 2-grid radial adsorbers containing, as single adsorption bed, a molecular sieve bed are employed, the adsorbers of a given pair operating alternately and the N′ pairs following the same pressure cycle in parallel, with N≧1 and N′≧1.

19. The process of claim 18, wherein the hourly molar flow rate of the treated feed gas stream is between 100,000 Nm³/h and 3,000,000 Nm³/h.

20. The process of claim 13, wherein the adsorbers employed in step a) are periodically regenerated with a regeneration gas heated by means of a first heater and in that the adsorbers employed in step b) are periodically regenerated with a regeneration gas heated by means of a second heater.

21. The process of claim 13, wherein the adsorbers employed in steps a) and b) are periodically regenerated with a regeneration gas heated by means of a single heater.

22. The process of claim 13, wherein the feed gas is air and the main component is oxygen.

23. The process of claim 14, wherein the adsorber employed in step b) has a size smaller than or equal to the size of the adsorber employed in step a) in a ratio ranging from 0.4 to 1.

24. The process of claim 23, wherein each adsorber is subjected to a pressure/temperature cycle, the duration of the cycle of the adsorber(s) employed in step a) being between 90 and 600 minutes and the duration of the cycle of the adsorber(s) employed in step b) being less than or equal to the duration of the cycle employed in step a) in a ratio of between 0.4 and 1.

25. The process of claim 24, wherein, in step a) N pairs of 2-grid radial adsorbers containing, as single adsorption bed, a bed of activated alumina or silica gel are employed, the adsorbers of a given pair operating alternately and the end pairs following the same pressure cycle in parallel and/or in that in step b) N′ pairs of 2-grid radial adsorbers containing, as single adsorption bed, a molecular sieve bed are employed, the adsorbers of a given pair operating alternately and the N′ pairs following the same pressure cycle in parallel, with N≧1 and N′≧1.

26. The process of claim 25, wherein the hourly molar flow rate of the treated feed gas stream is between 100,000 Nm³/h and 3,000,000 Nm³/h.

27. The process of claim 26, wherein the adsorbers employed in step a) are periodically regenerated with a regeneration gas heated by means of a first heater and in that the adsorbers employed in step b) are periodically regenerated with a regeneration gas heated by means of a second heater.

28. The process of claim 26, wherein the adsorbers employed in steps a) and b) are periodically regenerated with a regeneration gas heated by means of a single heater.

29. The process of claim 26, wherein the feed gas is air and the main component is oxygen.

30. A plant for purifying a feed gas stream comprising a main component, water (H₂O) and carbon dioxide (CO₂) together with secondary impurities (CₙHₘ, nitrogen oxides), said plant comprising at least one 2-grid radial adsorber containing, as single adsorption bed, a bed of activated alumina or silica gel and at least one 2-grid radial adsorber containing, as single adsorption bed, a molecular sieve bed, characterized in that the two radial adsorbers are placed in series.

31. The plant of claim 30, wherein said plant comprises at least one pair of 2-grid radial adsorbers containing, as single adsorption bed, a bed of activated alumina or silica gel and operating alternately and at least a second pair of 2-grid radial adsorbers containing, as single adsorption bed, a molecular sieve bed and operating alternately, the first and second pairs of radial adsorbers being placed in series.
